(19) United States
(12) Patent Application Publication
(10) Pub. No.: US 2026/0244173 A1
(43) Pub. Date: Aug. 20, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Kawasaki-shi (JP)

(72) Inventors: Makihiko ISHITANI, Yokohama Kanagawa (JP); Kenji HIROHATA, Koto Tokyo (JP); Akira KANO, Kawasaki Kanagawa (JP)

(73) Assignee: KABUSHIKI KAISHA TOSHIBA, Kawasaki-shi (JP)

(21) Appl. No.: 19/462,219

(22) Filed: Jan. 28, 2026

(30) Foreign Application Priority Data
Feb. 17, 2025 (JP) 2025-023164

(51) Int. Cl. G05B 13/04; G06F 11/34

(52) U.S. Cl. CPC G05B 13/048; G05B 13/041; G06F 11/3447

(57) ABSTRACT

An information processing device according to an embodiment includes a processor. The processor predicts at least one of a performance indicator of a device or a reliability indicator of the device by using a predictive model. The predictive model serves to predict at least one of the performance indicator or the reliability indicator by sampling probability distribution data for global variables and probability distribution data for local variables. The processor controls a controllable variable value, a range of controllable variable values, or a probability distribution of controllable variable values among the local variables based on at least one of the performance indicator or the reliability indicator. The processor generates, based on the controlled local variables, a glocal adapter management model serving to run a simulation to predict at least one of the performance indicator or the reliability indicator by the predictive model.

### CROSS-REFERENCE TO RELATED APPLICATIONS

This application is based upon and claims the benefit of priority from Japanese Patent Application No. 2025-023164, filed on Feb. 17, 2025; the entire contents of which are incorporated herein by reference.

### FIELD

Embodiments described herein relate generally to an information processing device, an information processing method, and a computer program product.

### BACKGROUND

In a customer use environment, a target system and a device component that is a component of the system are required to be designed and operated to satisfy customer requirements for performance and lifetime, and the like. When designing and operating to satisfy the customer requirements, it is necessary to consider both local information, such as design specifications and individual differences of the device component, and global information, such as an installation environment and usage of a customer system.

However, with conventional techniques, it has been difficult to more accurately predict a performance indicator and/or a reliability indicators of the system.

### BRIEF DESCRIPTION OF THE DRAWINGS

FIG. 1 is a diagram for describing a relationship between a damage probability and a performance indicator or a lifetime indicator, and performance criteria and lifetime criteria;

FIG. 2 is a diagram illustrating an example of a functional configuration of an information processing device of a first embodiment;

FIG. 3 is a diagram illustrating an example of a functional configuration of a generator of the first embodiment;

FIG. 4 is a diagram illustrating an example of surrogate AI of the first embodiment;

FIG. 5 is a flowchart illustrating an example of an entire procedure of an information processing method of the first embodiment;

FIG. 6 is a diagram illustrating control of an adjustment target by the surrogate AI in the first embodiment;

FIG. 7 is a diagram for describing a safety factor (margin) of the first embodiment;

FIG. 8 is a schematic diagram for describing an example of controlling the adjustment target by the surrogate AI of the first embodiment;

FIG. 9 is a flowchart illustrating an example of a generation method of the surrogate AI in the first embodiment;

FIG. 10 is a diagram for describing a first modification of the first embodiment;

FIG. 11 is a diagram for describing a second modification of the first embodiment;

FIG. 12 is a diagram illustrating a functional configuration of a generator of the second embodiment;

FIG. 13 is a diagram illustrating a functional configuration of a generator of a third embodiment;

FIG. 14 is a diagram illustrating a configuration according to an automatic updating function of a generator of the fourth embodiment; and

FIG. 15 is a diagram illustrating an example of a hardware configuration of the information processing device of the first to the fourth embodiments.

### DETAILED DESCRIPTION

An information processing device according to one embodiment includes a hardware processor connected to one or more memories. The hardware processor is configured to acquire probability distribution data for global variables and probability distribution data for local variables. The probability distribution data for the global variables includes at least one variable related to a global system in which a device of an adjustment target is included as a component of the global system. The probability distribution data for the local variables includes at least one variable related to the device of the adjustment target. The hardware processor is configured to predict at least one of a performance indicator of the device or a reliability indicator of the device by using a predictive model. The predictive model serves to predict at least one of the performance indicator or the reliability indicator by sampling the probability distribution data for the global variables and the probability distribution data for the local variables. The hardware processor is configured to control a controllable variable value, a range of controllable variable values, or a probability distribution of controllable variable values among the local variables based on at least one of the performance indicator or the reliability indicator. The hardware processor is configured to generate, based on the controlled local variables, a glocal adapter management model serving to run a simulation to predict at least one of the performance indicator or the reliability indicator by the predictive model.

Since characteristics, an installation environment, and degradation progress of a device component vary from product to product, variation among devices components is taken into account, a safety factor (margin) is established, and then the device components are designed. However, performance and degradation progress, or the like assumed at the time of design may differ significantly from performance and degradation progress, or the like of an individual product in an actual use environment.

In such cases, performance and service life, or the like may deteriorate because designed parameters are not adequate.

If the design parameters of device components can be adjusted to appropriate parameters by combining information from both the global side (customer use environment) and the local side (device component), it can provide an ability to properly manage performance and lifetime to satisfy customer requirements.

However, local side information also includes confidential information (e.g., tolerances of constituent materials and structural dimensions) and know-how (e.g., detailed relationships of phenomenon responses to design variables such as loads) on a device component manufacturers side, and much of these pieces of information is not provided as device component specifications.

In addition, information about a customer system side, such as installation environment and usage information, includes confidential information and know-how, and the like, and in many cases cannot be provided to the manufacturer side. Therefore, it is often difficult to properly manage performance and lifetime to satisfy customer requirements by combining information from both the global and local sides.

Embodiments of an information processing device, an information processing method, and a computer program product that can more accurately predict at least one of a performance indicator or a reliability indicator of the system will be described below with reference to the accompanying drawings.

### First Embodiment

First, a relationship between: a damage probability or a breakdown rate or a failure probability (failure rate) with respect to performance and lifetime, and a performance indicator, a lifetime indicator, performance criteria, and lifetime criteria will be described.

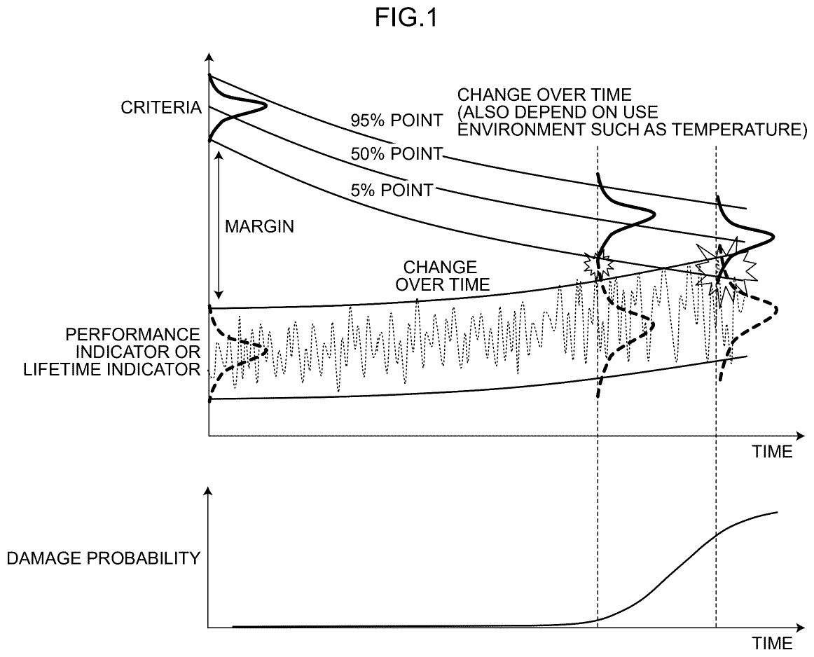

FIG. 1 is a diagram for describing a relationship between a damage probability, a performance indicator, a lifetime indicator, performance criteria, and lifetime criteria.

As illustrated in FIG. 1, a probability distribution of the damage probability is determined by the respective probability distributions of an indicator for predicting performance (performance indicator), an indicator for predicting a lifetime (lifetime indicator), performance criteria, and lifetime criteria, and the respective margin designs.

In addition, the performance criteria, the lifetime criteria, the performance indicator and the lifetime indicator change over time.

Moreover, the probability distribution of the performance indicator and the probability distribution of the lifetime indicator are determined depending on both the information about the design specifications and individual differences of the device components on the local side and the information on the global side. The information on the global side is, for example, information about how the global customer system is used and the use environment, such as the installation environment.

In addition, the manufacturer on the local side provides test results from industry-standard accelerated reliability test conditions of the device component to customers on the global side. However, in many cases, detailed relationships such as design variables, load conditions, and boundary conditions on reliability-related phenomena, and models related to probability distributions, cannot be provided because they contain confidential information and know-how, and the like.

In addition, the configuration, load conditions, installation conditions, environmental conditions, and operational conditions of the customer system on the global side also contain confidential information and know-how, and the like, and thus the customer is often unable to provide these pieces of data and the models related to probability distributions to the manufacturer on the local side.

The first embodiment describes an embodiment of a performance and lifetime management simulator (with model identification) using a glocal adapter management model. Specifically, in the first embodiment, description is made with an example of a storage battery system that controls storage batteries by means of a glocal adapter management model implemented by surrogate artificial intelligence (AI).

In the present embodiment, information pertaining to the device itself, including an adjustment target by an information processing device 1, may be described as “information on the local side,” and the system that includes the device as a component may be described as the “global system”, and information pertaining to the global system as “information on the global system side”.

In addition, a device component is each of the components of a device. In the first embodiment, the device is a storage battery system including a plurality of battery modules and power electronics modules. Moreover, the device component is the battery module, which is a component of the storage battery system, and the power electronics module.

### Example of Functional Configuration

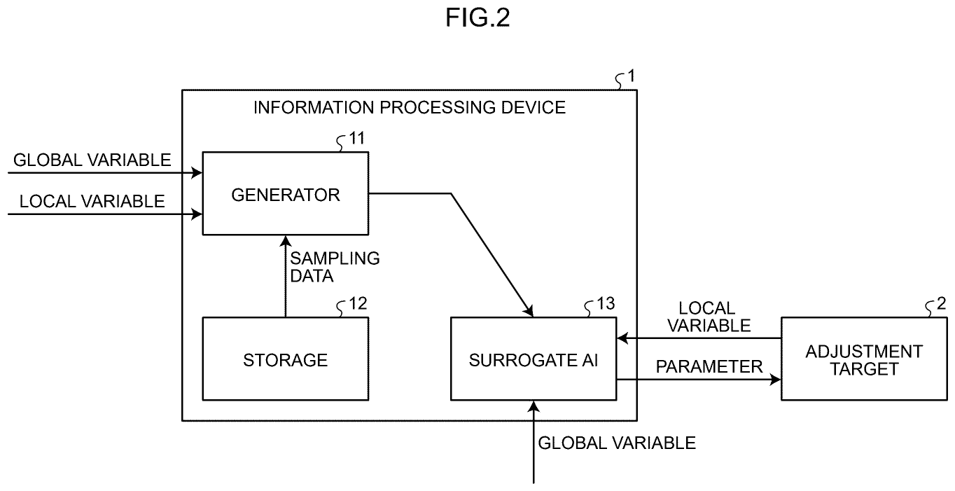

FIG. 2 is a diagram illustrating an example of a functional configuration of the information processing device 1 of the first embodiment. The information processing device 1 of the first embodiment includes a generator 11, a storage 12, and a surrogate AI 13.

The generator 11 generates the surrogate AI 13 (glocal adapter management model).

The storage 12 stores a surrogate model base (equipped with surrogate models for various phenomenon analyses such as electric circuit analysis, thermal analysis, and lifetime analysis) and a phenomenon analysis database.

The surrogate AI 13 outputs at least one of a performance indicator or a reliability indicator under control conditions that satisfy device conditions defined by the local variables described below and required specifications defined by the global variables described below. The surrogate AI 13 also controls the parameters of an adjustment target 2 based on the global variables and the local variables.

In a case where the surrogate AI 13 cannot satisfy the required specifications of the global system defined by the global variables, the surrogate AI 13 changes at least one of the conditions of the device defined by the local variables or the conditions of the global system defined by the global variables, and predicts again at least one of a performance indicator or a reliability indicator.

The adjustment target 2 is the battery module and the power electronics module, which are components of the storage battery system.

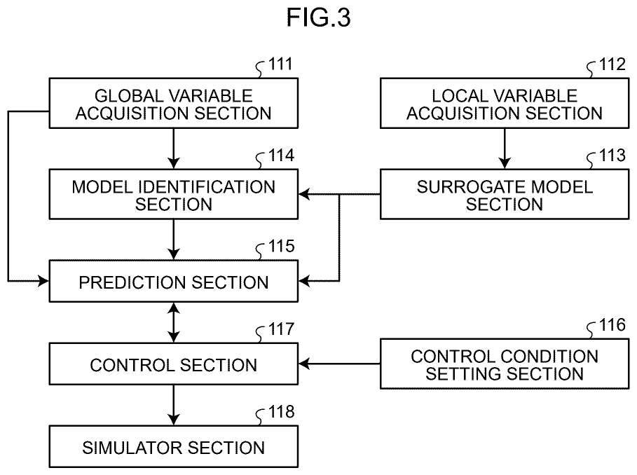

FIG. 3 is a diagram illustrating an example of a functional configuration of the generator 11 of the first embodiment. The generator 11 of the first embodiment includes a global variable acquisition section 111, a local variable acquisition section 112, a surrogate model section 113, a model identification section 114, a prediction section 115, a control condition setting section 116, a control section 117, and a simulator section 118.

The global variable acquisition section 111 acquires global variables that indicate system conditions, including performance and lifetime indicators of the adjustment target 2 on the global side. The global variables are acquired from the customer system side.

The global variables indicate the required specifications of performance and reliability indicators, system configuration specifications, load conditions, use environmental conditions, and disturbances of the adjustment target 2 on the global side system in which the device component is a component. For example, the global variables include at least one of a variable indicating a required specification of the device, a variable indicating a system configuration specification of the device, a variable indicating a load condition of the device, a variable indicating a use environmental condition of the device, or a variable indicating a disturbance of the device.

The local variable acquisition section 112 acquires local variables that indicate device component conditions on the local side. The local variables are acquired from the device component manufacturer side.

The local variables indicate device component conditions on the local side of the system components. The device component conditions are probability distributions representing structural conditions, material properties, boundary conditions, initial conditions, and individual differences. The local variables include at least one of a variable indicating a structure of the device, a variable indicating material properties of the device, a variable indicating boundary conditions of the device, a variable indicating initial conditions of the device, or a variable indicating individual differences of the device.

Note that the global variable acquisition section 111 and the local variable acquisition section 112 may be implemented as a single variable acquisition section.

The surrogate model section 113 generates the surrogate AI 13 from the surrogate model base and the phenomenon analysis database described above. The surrogate AI 13 is a model that samples probability distribution data for global variables and probability distribution data for local variables to predict performance and reliability indicators.

The surrogate model section 113 generates the predictive models included in the surrogate AI 13 from a group of surrogate models that includes one or more surrogate models. The surrogate model predicts at least one of a performance indicator or a reliability indicator of the device by sampling the probability distribution data for global variables and the probability distribution data for local variables.

The surrogate model section 113 is implemented by Operator Learning of differential equations for load conditions, structural conditions, material conditions, initial conditions, and boundary conditions, and a generative AI model. Specifically, the surrogate model section 113 is an AI, such as Neural Operator with Transformer or Normalizing Flow with VAE.

The surrogate AI 13 generated by the surrogate model section 113 is adjusted by the model identification section 114, the prediction section 115, the control condition setting section 116, the control section 117, and the simulator section 118, before being output from the generator 11.

The model identification section 114 identifies global variables and model data for the surrogate AI 13 regarding performance and reliability indicators from monitoring/measurement data for load patterns during trial operation or in operation.

The prediction section 115 predicts performance and reliability indicators by sampling the probability distribution data for global variables and the probability distribution data for local variables.

The performance and reliability indicators are used for evaluating, for example, the probability that performance or reliability will not satisfy the required specifications, or the risk. Specifically, the performance and reliability indicators are represented by a damage probability (failure rate), a probability distribution of the damage probability (failure probability), or a risk value. The risk value may be represented by a product of a loss cost that indicates a magnitude of a loss and occurrence probability of the loss.

The control condition setting section 116 sets control conditions. The control conditions include variables that can be controlled (for example, model predictive control, consensus control, or control by multi-agent models) among the global variables, a timing that can be corrected, and a range (or probability distribution) that can be corrected.

The control section 117 controls controllable local variables among the local variables of the surrogate AI 13 based on the predicted performance and reliability indicators. For example, the control section 117 performs model predictive control, control based on a multi-agent model, or consensus control for controllable variables among the local variables of the surrogate AI 13.

The simulator section 118 runs a simulation by using the surrogate AI 13 whose local variables are controlled by the control section 117. Specifically, the simulator section 118 runs a simulation to output a combination of correction control variable values (including the timing at which correction control is performed) that satisfy the required specifications for performance and reliability indicators in the global side system, taking into account the device component conditions on the local side, and the performance and reliability indicators.

The simulator section 118 generates candidate combinations of control variables for appropriate operation (operational control scenarios) or candidate combinations of management variables for appropriate regeneration (regeneration scenarios) to align customer requirements and customer use environmental conditions on the global side, and device component specifications and individual differences on the local side.

In the case of not satisfying the required specifications, the simulator section 118 modifies the global side or the local side conditions and re-executes the simulation.

The generator 11 outputs the surrogate AI 13 adjusted by the simulator section 118. The surrogate AI 13 is used as a glocal adapter to control the parameters of the adjustment target 2.

The following describes a generation method of the glocal adapter management model (surrogate AI 13).

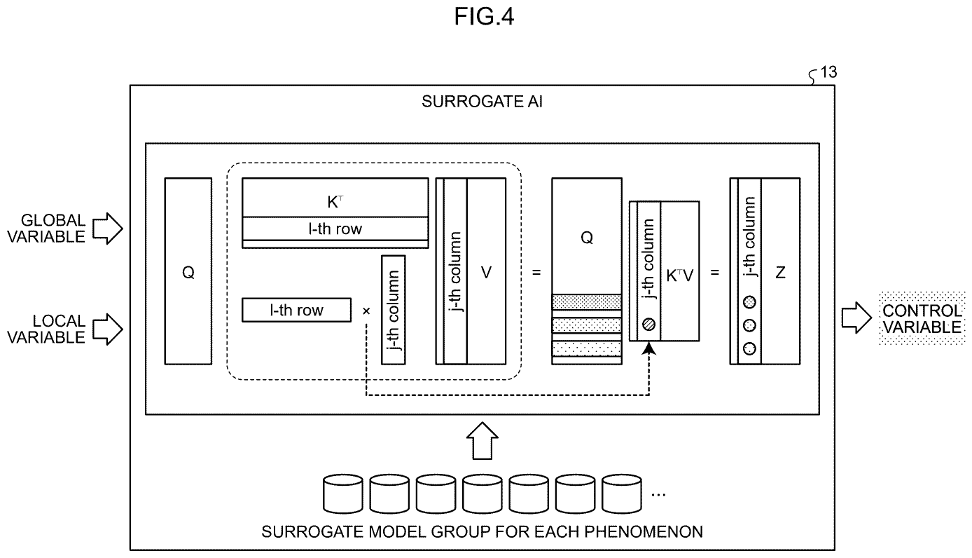

FIG. 4 is a diagram illustrating an example of the surrogate AI 13 of the first embodiment. As a preliminary preparation, the surrogate model section 113 described above prepares a surrogate model base (a group of surrogate models for each phenomenon) containing one or more surrogate models.

Specifically, the surrogate model section 113 first conducts a parameter survey of the simulation while generating sampling points for numerical experiments on local variables and global variables, to prepare the phenomenon simulation data set. The phenomenon simulation datasets are stored in the phenomenon analysis database.

In the first embodiment, the local variables include variables of a battery storage system that includes a plurality of battery modules and power electronics modules (for example, a regenerative power storage system TESS: Traction Energy Storage System, or the like). Specifically, the local variables include variables related to structural conditions, material properties, boundary conditions, and initial conditions of the battery module and the power electronics module.

The global variables also include the system condition variables of the storage battery system (for example, system configuration specifications, load conditions, use environmental conditions, and disturbances).

Hereafter, the global variables and the local variables may be collectively referred to as “glocal variables”.

Next, the surrogate model section 113 generates, based on a dataset of phenomenon simulation data (combinations of the glocal variables and the phenomenon outcome data), a surrogate model base including one or more surrogate models, each of which outputs partial phenomenon indicators in response to receiving input of partial glocal variables related to performance and reliability.

Next, the surrogate model section 113 generates a training data set for the surrogate AI 13 by utilizing a group of surrogate models with both global and local variables involved in the system (glocal variables) as inputs and phenomenological indicators for performance and reliability as outputs.

The inputs to the surrogate AI 13 are the phenomenon indicators for the surrogate AI learning and all glocal variables regarding the performance and reliability indicators that prepare sampling data for the global variables and the local variables.

The outputs of the surrogate AI 13 are the control variables for all the phenomenon indicators.

Note that the performance and reliability indicators are quantitative measure indicators for performance or reliability of the device. In the case of batteries, performance includes battery charging and discharging characteristics (C-rate, Depth of Discharge, etc.), cooling performance, power electronics performance, battery life, power electronics life, and probability distributions (probability models and model parameters) that represent their uncertainties.

Next, the surrogate model section 113 generates the surrogate AI 13 by training the spatial and temporal responses of the phenomenon state quantities regarding performance and reliability, the phenomenon criteria, and the operators of the differential equations, utilizing a Neural Operator or Transformer, or the like. The differential equations to be learned include load conditions, boundary conditions, configuration and structural conditions, material property conditions, and initial conditions.

The feature of the first embodiment is that in the process of generating the surrogate AI 13, regular conditions are imposed to facilitate convergence of a learning error of the surrogate AI 13 by generating a constraint condition based on combinations of function candidates obtained from a function candidate library. The function candidate library includes physical and engineering models based on the mechanism of the phenomenon, and functions representing energy functionals, information entropy, and the like.

Latent variables (feature quantities) may also be extracted from the glocal variables by a generative AI method such as normalizing-flow VAE at the stage of setting up the surrogate AI 13 configuration.

The latent variables (feature quantities) are, for example, feature quantities of the phenomenon indicators regarding performance and reliability. In addition, for example, latent variables (feature quantities) are feature quantities of the phenomenon criteria. Moreover, for example, latent variables (feature quantities) are feature quantities of multivariable probability distributions related to load conditions, boundary conditions, configuration and structural conditions, material property conditions, and initial conditions.

In this case, the glocal variables are converted to latent variables (feature quantities), an input and output configuration of the surrogate AI 13 is set to the latent variables (feature quantities), and then the surrogate AI 13 is generated.

In a case where the learning error does not satisfy the required specification during the learning process of the surrogate AI 13, the surrogate model section 113 expands the phenomenon simulation data set described above, and executes the processing described above repeatedly until the learning error satisfies the required specification.

The surrogate model section 113 automatically generates the surrogate AI 13 that implements a glocal adapter through the above processing.

The following section describes processing in the case of simulating prediction and management regarding performance and reliability (lifetime) with the surrogate AI 13 generated by the surrogate model section 113.

The prediction and management regarding performance and reliability (lifetime) are simulated by a model identified by the model identification section 114.

The global variable acquisition section 111 acquires the global variables including the required specifications of the performance and reliability indicators, the system configuration specifications, the load conditions, the use environmental conditions, and the disturbances of the adjustment target 2 in the global system.

The required specifications are specifications required by the customer to satisfy performance and reliability, and the like. For example, in the case of TESS, an example of a required specification is as follows:
Failure probability of 0.1% or less over an operational period (e.g., 20 years)
Failure probability of 0.1% or less during the period up to the timing of cascade reuse (e.g., 10 years of operation)
Failure probability of 0.01% in the period of time between device component replacements of the system components (e.g., 5 years of operation)
Performance degradation of 5% or less during the operation period (occurrence probability of 0.1% or less)

The system configuration specifications indicate specifications that make up the global system. For example, in the case of TESS, an example of the system configuration specifications is as follows:
Series and parallel configurations of batteries
Configurations of a battery cell, a battery module, a battery pack, and a battery system
Power electronic systems such as inverters, converters and capacitors
Configurations of battery packs
Configurations of air-cooling systems

Load conditions are conditions under which a system and device components as the system components are loaded. Examples of the load conditions include power waveforms of charging and discharging, State of charge (SOC) waveform, temporal and spatial temperature waveforms, and probability distributions representing their degree of uncertainty.

The use environmental conditions are conditions of the installation environment in which the system is installed and used. Examples of the use environmental conditions include the ambient temperature and humidity, and the like of the TESS installation.

Disturbances are the effects within the system due to physical and chemical noise (temporal and spatial distribution) from outside the system. In the case of TESS, examples of the disturbances include electromagnetic noise and environmental vibration.

Local variables are as follows:
Variables related to structure, material properties, boundary conditions, and initial conditions of battery cell
Variables related to structure, material properties, boundary conditions, and initial conditions of battery modules
Equivalent electrical network parameters
Thermal network parameters
Degradation model parameters
Criteria variables (e.g., lifetime definition variables)

The performance includes battery charging and discharging characteristics (C-rate, Depth of discharge, etc.), cooling performance, power electronics performance, battery life, power electronics life, and probability distributions (probability models and model parameters) that represent their uncertainties.

The prediction section 115 predicts performance and reliability from the input information of the glocal variables by using the surrogate AI 13 automatically generated by the surrogate model section 113 described above.

Specifically, the surrogate AI 13 first identifies glocal variables and model parameters of a surrogate model regarding performance and reliability indicators from the monitoring/measurement data for load patterns during system trial operation or operation. The surrogate AI 13 then samples the probability distribution data for global variables and the probability distribution data for local variables to predict performance and reliability indicators by using the identified glocal variables and model parameters of the surrogate model.

For example, in the case of an equivalent electrical network for each battery pack or each battery module, the surrogate AI 13 is an analogy of the Maxwell model identification method, which includes a plurality of series and parallel resistances and capacitances, and the like, from temperature-time conversion laws and dynamic vibration response tests (including frequency changes) of load patterns.

A hierarchical surrogate AI 13 may be constructed by stratifying the battery modules and the battery packs and identifying surrogate models.

Next, the adjustment processing for performance and lifetime management by the surrogate AI 13 will be described.

First, the control condition setting section 116 sets the control conditions for the variables that can be controlled (model predictive control, consensus control, or control by a multi-agent model) among the glocal variables, the timing at which correction control is possible, and the range (or probability distribution) within which correction is possible.

The control section 117 then controls controllable local variables among the local variables based on the predictions of the performance and reliability indicators obtained by sampling.

Finally, the simulator section 118 runs a simulation for the management of performance and lifetime (reliability) by using the surrogate AI 13 with the local variables controlled by the control section 117.

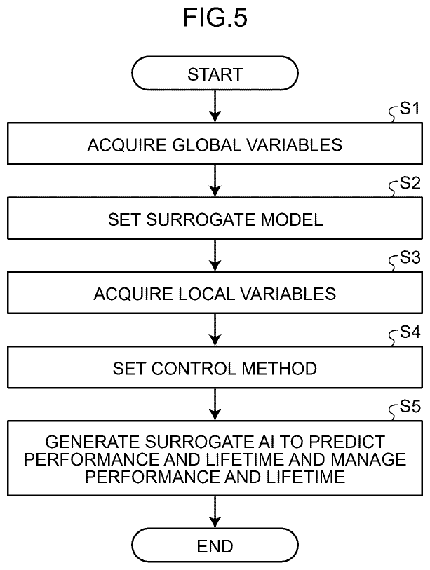

FIG. 5 is a flowchart illustrating an example of an entire procedure of an information processing method of the first embodiment. First, the global variable acquisition section 111 acquires global variables including customer system requirements (e.g., damage probability thresholds), system configuration conditions, and load, use environment, and boundary conditions (including monitoring data), and the like (step S1).

Next, the surrogate model section 113 sets the surrogate model used for predicting the performance and lifetime indicators (e.g., damage probability) of the system identified by the global variables, based on a group of surrogate models including one or more surrogate models (step S2).

Next, the local variable acquisition section 112 acquires the local variables used in the surrogate model that has been set (step S3). The local variables include structures and material conditions of the device components, criteria detailed information (including probability distribution), and tolerance information (including probability distribution), and the like.

Next, the surrogate model section 113 sets up a control method for the surrogate AI 13 that predicts performance and lifetime indicators (step S4). For example, a method by a multi-agent model is used as the control method.

In the case of employing a control method by a multi-agent model, each device individual may be subjected to agentification, or each device individual may be modeled as an agent for each performance indicator and each lifetime indicator, or a calculation section, a control section, and a monitoring section for performance and lifetime may be modeled as an agent, or those sections may be modeled as their composition. The multi-agent model allows each agent to take, while receiving environmental variables and state variables of each agent, action of predicting performance and lifetime, and failure rate, or action of adjusting control variables, or action of reusing the device, or action of maintaining the device (e.g., cleaning fins or replacing parts), and also, in order to optimize the value function of maximizing lifetime or minimizing failure rate, performs optimization under constraint conditions (e.g., within energy consumption defaults, within total cost defaults, and the like).

The control method of the surrogate AI 13 is not limited to those described above. For example, the control method of the surrogate AI 13 may be by consensus control or model predictive control.

In the case of employing consensus control, the behavior of each agent is such that some of the variables of each agent in the multi-agent model are aligned. The variables for each agent to align values may be performance and lifetime and Failure rate, or may be local variables. An example of a method for determining the behavior of each agent, it can be considered that a difference between the focused agent and the unfocused agent with respect to the variable whose values are to be aligned is calculated, and the difference is multiplied by a coefficient to determine the amount of movement of the focused agent. The calculation is performed for each agent that operates. In the calculation of the difference between the focused agent and the unfocused agent, it is not necessary to use all the agents other than the focused agent as the unfocused agents, but only one agent may be used as the unfocused agent.

In the case of employing the model predictive control, the operating waveform is optimized after the future waveform of the system is estimated at each sampling. The amount of motion at the current time of the optimized motion waveform is used as the amount of motion for that sampling. Surrogate models may be used for estimating the future waveform of the system. The performance and lifetime and Failure rate waveforms, local variable waveforms, and operating waveforms may be used for the value function during optimization. During optimization, constraint conditions may be set on the system waveform and operating waveform.

Next, the simulator section 118 manages the performance and lifetime of the system by using the surrogate model AI generated by the surrogate model section 113 and adjusted by the model identification section 114, the prediction section 115, the control condition setting section 116 and the control section 117 (step S5).

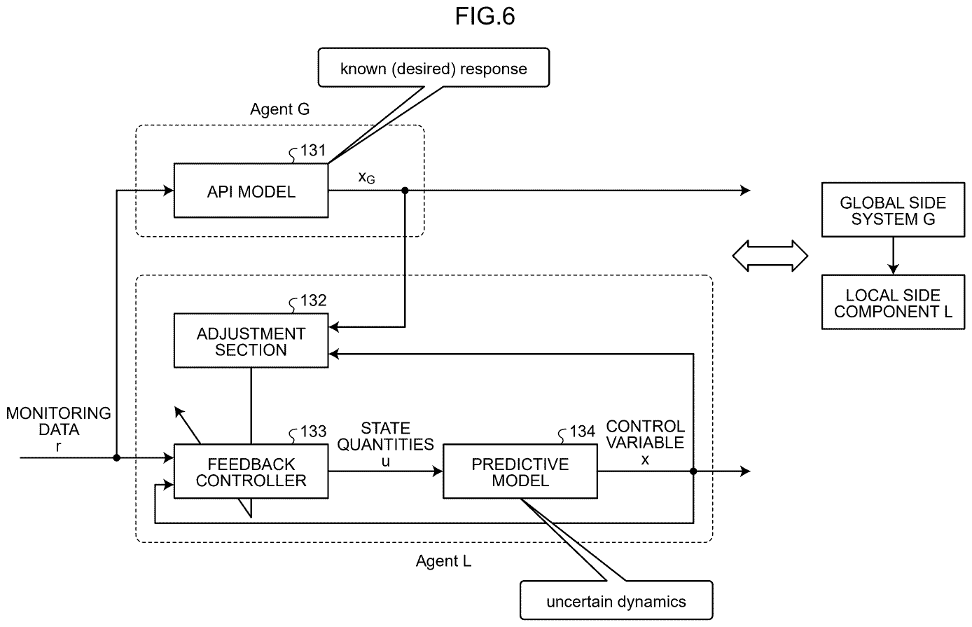

FIG. 6 is a diagram illustrating control of the adjustment target 2 by the surrogate AI 13 in the first embodiment. The example in FIG. 6 illustrates a case where a multi-agent model is set up as a control method to manage performance and lifetime.

In the example in FIG. 6, the surrogate AI 13 includes agents G and L.

The agent G includes an application programming interface (API) model 131. The agent G receives a system request (customer system request) of the global side system G among the monitoring data r.

The agent L includes an adjustment section 132, a feedback controller 133, and a predictive model 134. The agent L receives both the global and local variables (glocal variables) described above. Specifically, the agent L receives load variables, environmental variables, boundary conditions, and the like among the monitoring data r.

The parameters of the API model 131 and the predictive model 134 are identified by the model identification section 114 described above.

The API model 131 is a model that enables API functionality for modeling customer interfaces. The API model 131 models customer system usage conditions (load waveform conditions, environmental conditions, boundary conditions, and system configuration conditions) to be consistent with the input format of the forecast model 134.

For example, the API model 131 creates a load model with amplitude, period, and load rate as variables by spectralizing the load waveform over a predetermined period of time in the customer use environment.

The predictive model 134 is a surrogate model that enables simulation and forecasting capabilities. Upon input of a glocal variable, the predictive model 134 simulates and predicts the damage probability with respect to the performance and lifetime indicators of the device component, taking into account the uncertainties of the glocal variable. The predictive model 134 then outputs a combination of control variables and safety factors (margins) that satisfy customer requirements.

The predictive model 134 may utilize the input monitoring data r to identify some variables (or model parameters) of the surrogate model or the lifetime model utilizing data assimilation techniques before predicting the performance and lifetime.

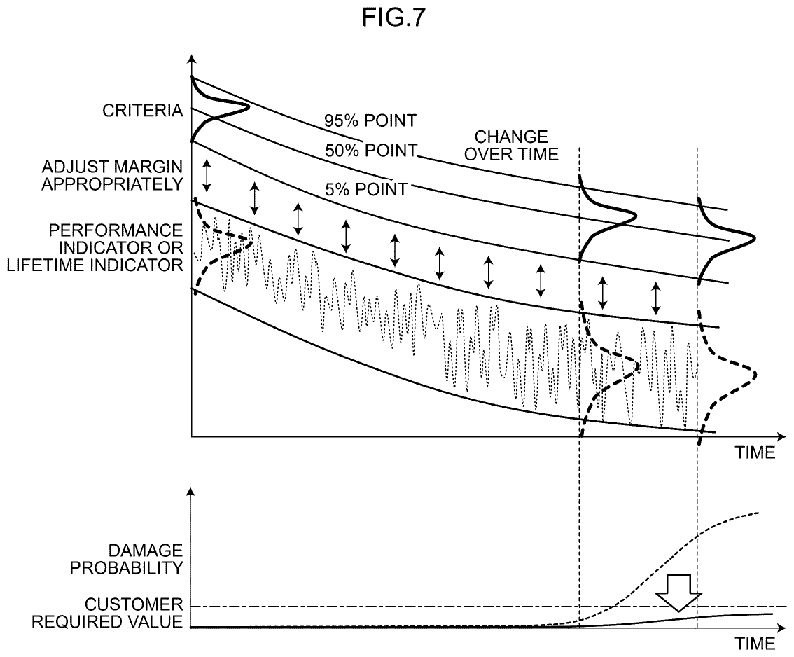

FIG. 7 is a diagram for describing a safety factor (margin) of the first embodiment. The surrogate AI 13 outputs a combination of control variables and safety factors (margins) that satisfy the customer requirements. By setting the safety factor (margin) of the adjustment target 2 to the safety factor (margin) output from the surrogate AI 13, it is possible to adjust the safety factor (margin) of the adjustment target 2 to a more appropriate value.

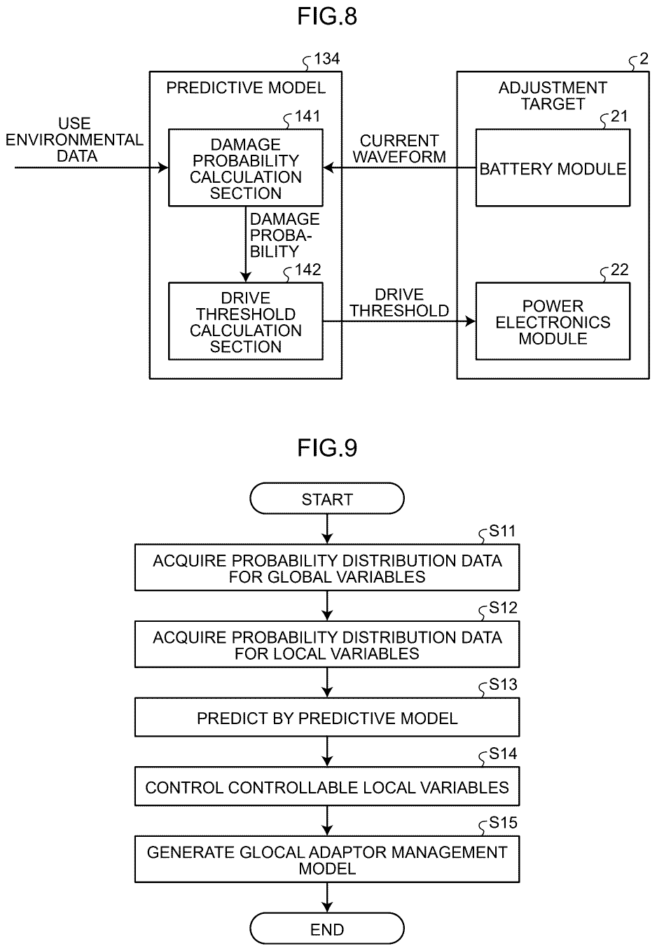

FIG. 8 is a schematic diagram illustrating an example of controlling the adjustment target 2 by the surrogate AI 13 of the first embodiment.

The predictive model 134 of the surrogate AI 13 includes a damage probability calculation section 141 and a drive threshold calculation section 142.

The adjustment target 2 includes a battery module 21 and a power electronics module 22. The power electronics module 22 includes, for example, power electronics equipment and a cooler that cools the power electronics equipment.

The use environment data (e.g., ambient temperature) is input to the damage probability calculation section 141 as the global variable described above, and the current waveform of the battery module 21 is input as the local variable described above.

The damage probability calculation section 141 calculates the damage probability of the adjustment target 2 (e.g., a container, a battery pack, a battery string or the battery module 21) based on the input global and local variables.

The drive threshold calculation section 142 adjusts the drive threshold of the local variable according to the calculated damage probability.

In one example, the local variables include variables that affect the battery charging and discharging waveform, such as battery charging and discharging thresholds (upper limit and lower limit values). In one example, the local variables also include variables that affect the drive waveform and thus the lifetime of the power electronics module 22 (e.g., drive current frequency). In one example, the local variables also include variables related to cooling performance, such as cooling fan rotation speed.

As a result of adjusting the drive threshold illustrated in FIG. 8 above, for example, the following effects can be obtained.
The container that is not deteriorating allows the batteries to be charged and discharged rapidly.
Energy can be saved by reducing the drive energy of the fan.
The container that is deteriorating and the power electronics module 22 allow charging and discharging waveforms to be improved so as to achieve longer life.
The increased fan drive volume and more efficient cooling can extend the service life of the adjustment target 2.

Battery cells have individual differences, and the battery modules 21 and battery packs also include individual differences in charging and discharging characteristics. After individual differences are identified by monitoring data through trial operation, performance and lifetime can be predicted by the surrogate AI 13 (glocal adaptor), thereby making it possible to present combinations of control variables that can respond to various load patterns required by customers, taking individual differences into account.

FIG. 9 is a flowchart illustrating an example of a generation method of the surrogate AI 13 of the first embodiment.

First, the global variable acquisition section 111 acquires probability distribution data for global variables including at least one variable related to a global system that includes the device of the adjustment target 2 as a component (step S11).

Next, the local variable acquisition section 112 acquires probability distribution data for local variables including at least one variable related to a device that is a component of the global system (step S12).

Next, the prediction section 115 predicts at least one of a performance indicator or a reliability indicator of the device by using the predictive model 134 that predicts at least one of the performance indicator or the reliability indicator of the device by sampling the probability distribution data for global variables and the probability distribution data for local variables (step S13).

Next, the control section 117 controls the controllable variable values, a range of the controllable variable values, or a probability distribution of the controllable variable values among the local variables based on at least one of the performance indicator or the reliability indicator (step S14).

Next, the simulator section 118 generates, based on the controlled local variables, a glocal adapter management model (surrogate AI 13) that runs a simulation to predict at least one of the performance indicator or the reliability indicator by the predictive model 134 (step S15).

As described above, according to the information processing device 1 of the first embodiment, at least one of the system performance indicator or the reliability indicator can be predicted more accurately. Specifically, the glocal adapter management model (surrogate AI 13) can predict, for example, a damage probability (probability distributions of control indicators) from information about system conditions on the global side (global variables) and device component conditions on the local side (local variables).

The glocal adapter management model also identifies the respective probability distributions of the performance criteria and lifetime criteria, and information about the margin design described above, from the global and local variables, during the prediction.

For example, the glocal adapter management model allows the system to be controlled so that, upon input of specific global variables, the values of performance and lifetime damage probabilities can satisfy the customer requirements identified by the global variables.

The glocal adapter management model can change controllable variable values among the local variables that affect the control indicators and can output performance or lifetime damage probability. In other words, the glocal adapter management model is a mathematical model that is represented by internalizing the models (the group of surrogate models described above) in a form of not explicitly being visible regarding the relationships and probability distributions that local variables exert on control indicators.

The information processing device 1 of the first embodiment can be utilized for automatic correction and predictive maintenance of the device consistent with the customer use environment in the “operation and maintenance” department, for example, to improve reliability.

### First Modification of First Embodiment

Next, a first modification of the first embodiment will be described. In the first modification, contents similar to those in the first embodiment are omitted, and contents different from the first embodiment are described. The first modification describes a case where the adjustment target 2 is, for example, a power electronic device such as an elevator, a robot, an automobile, a motor, an electronic device, and an air conditioner.

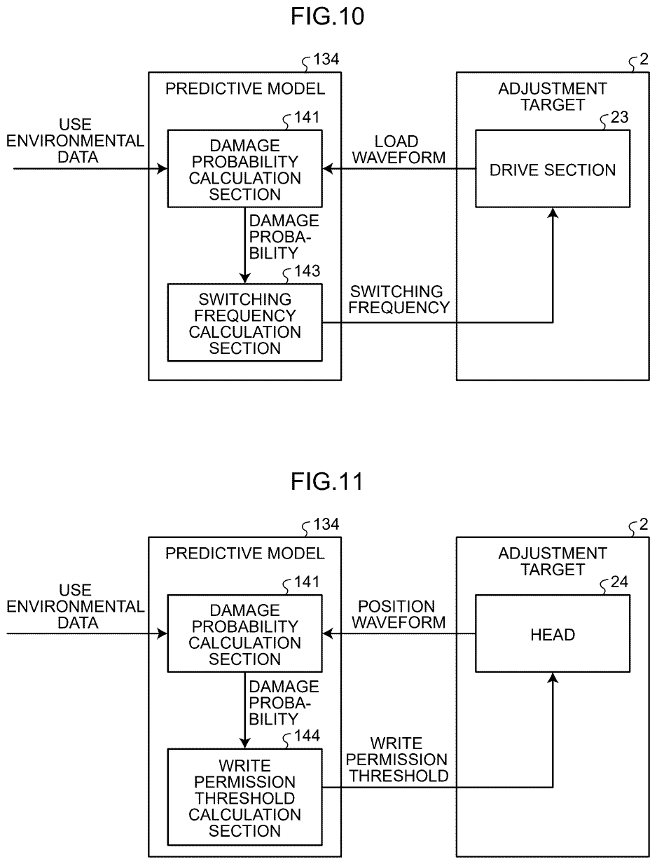

FIG. 10 is a diagram for describing a first modification of the first embodiment. The predictive model 134 of the surrogate AI 13 includes the damage probability calculation section 141 and a switching frequency calculation section 143.

The use environment data (e.g., ambient temperature) is input to the damage probability calculation section 141 as the global variable described above, and the load waveform of a drive section 23 is input as the local variable described above.

The damage probability calculation section 141 calculates the damage probability of the adjustment target 2 based on the input global and local variables.

The switching frequency calculation section 143 selects the switching frequency of the circuit of the drive section 23 according to the calculated damage probability.

### Second Modification of First Embodiment

Next, a second modification of the first embodiment will be described. In the the second modification, contents similar to those in the first embodiment are omitted, and contents different from the first embodiment are described. The second modification describes a case where the adjustment target 2 is a hard disk drive (HDD).

FIG. 11 is a diagram for describing the second modification of the first embodiment. The predictive model 134 of the surrogate AI 13 includes the damage probability calculation section 141 and a write permission threshold calculation section 144.

The damage probability calculation section 141 receives the use environment data as the global variable described above, and receives the local variables described above.

Specifically, when the adjustment target 2 is an HDD, the system configuration specifications for global variables include a configuration of a device in which the HDD is incorporated (CPU, rack, etc.), an HDD fixing method, an air-cooling system configuration, and the like.

Load conditions of the global variable include read-write commands, temporal and spatial temperature waveforms, and probability distributions representing their degree of uncertainty.

The use environment data includes use environmental conditions and disturbances, and the like. Examples of the use environmental conditions include the ambient temperature and humidity, and the like of the HDD installation. Examples of the disturbances include acoustic disturbance (fan vibration) of cooling fans, and vibration of other devices and HDDs.

Examples of the local variables include control parameters in seek control (position waveform of a head 24) in addition to the local variables regarding structure, material properties, boundary conditions, and initial conditions of HDD.

Examples of the performance includes head positioning accuracy during read and write, IOPS, power usage, and probability distributions (probability models and model parameters) for their uncertainties.

Examples of the model parameters include the frequency transfer characteristics of the vibration and the parameters of the state-space model, and the like.

### Second Embodiment

Next, a second embodiment will be described. In the second embodiment, contents similar to those of the first embodiment are omitted, and contents different from the first embodiment are described. The second embodiment describes the configuration in which the model identification section 114 described above is not provided.

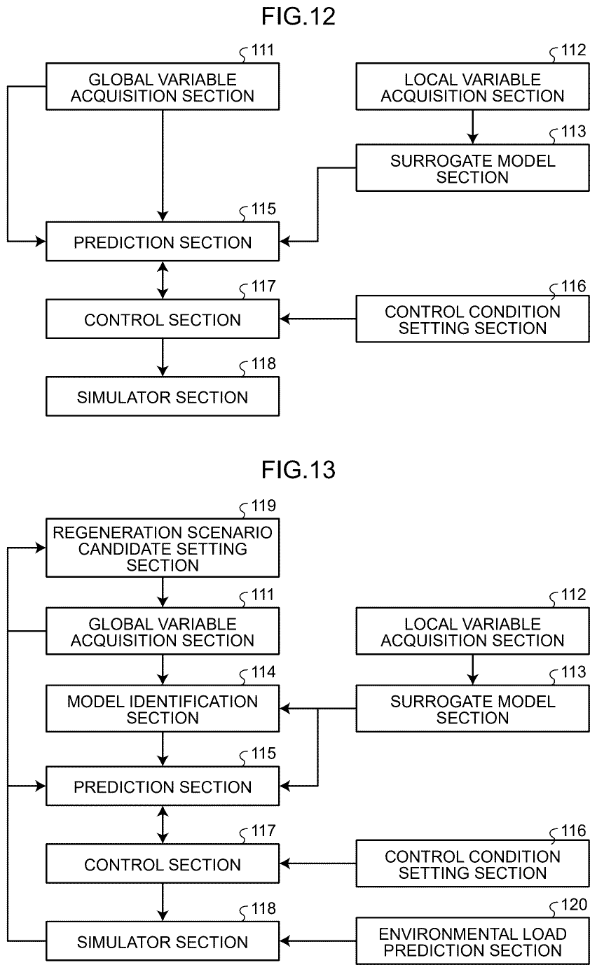

FIG. 12 is a diagram illustrating an example of a functional configuration of the generator 11 of the second embodiment. The generator 11 of the second embodiment includes the global variable acquisition section 111, the local variable acquisition section 112, the surrogate model section 113, the prediction section 115, the control condition setting section 116, the control section 117, and the simulator section 118.

The surrogate model section 113 generates the surrogate AI 13 from the surrogate model base (group of surrogate models) and the phenomenon analysis database described above.

In the second embodiment, as illustrated in FIG. 12, the surrogate AI 13 is adjusted by the prediction section 115, the control condition setting section 116, the control section 117, and the simulator section 118, without including the model identification section 114.

According to the second embodiment, it is possible to simulate performance and lifetime management of device components in customer systems. This will help visualize the total cost of ownership (TCO) advantage of device components, for example, in a “planning and sales” department. Also, for example, in a “design and development” department, the information processing device 1 of the second embodiment can be utilized for improvement of the reliability of device components under the customer system conditions.

### Third Embodiment

Next, a third embodiment will be described. In the third embodiment, contents similar to those of the first embodiment are omitted, and contents different from the first embodiment are described. The third embodiment describes a case where the performance required for the system includes environmental load, and environmental load prediction is also performed.

### Example of Functional Configuration

FIG. 13 is a diagram illustrating an example of a functional configuration of the generator 11 of the third embodiment. The generator 11 of the third embodiment includes the global variable acquisition section 111, the local variable acquisition section 112, the surrogate model section 113, the model identification section 114, the prediction section 115, the control condition setting section 116, the control section 117, the simulator section 118, a regeneration scenario candidate setting section 119, and an environmental load prediction section 120.

In the third embodiment, in addition to the configuration of the first embodiment, the regeneration scenario candidate setting section 119 and the environmental load prediction section 120 are added.

The regeneration scenario candidate setting section 119 sets selection of a cascade type reuse in a life cycle of a device component, timing of the selection, and a regeneration scenario candidate that indicate a target range of the cascade type reuse.

The global variable acquisition section 111 acquires global variables that further include variables related to environmental load performance as global variables that indicate system configuration specifications.

The local variable acquisition section 112 acquires local variables that further include variables related to environmental load performance as local variables that indicate device component conditions.

The environmental load prediction section 120 forecasts, by using a life cycle simulator, the environmental load of the regeneration scenario candidates set by the regeneration scenario candidate setting section 119, based on the global variables and the local variables.

The simulator section 118 runs a simulation by using the surrogate AI 13 whose local variables are controlled by the control section 117. The simulator section 118 of the third embodiment outputs a combination of correction control variable values (including timing for performing correction control) and performance and reliability indicators that further satisfy the required specifications for environmental load in the global side system, taking into account device component conditions on the local side.

According to the third embodiment, it is useful to consider the regeneration (reuse, recycle, refurbish, and/or disposal) of the system. For example, the information processing device 1 of the third embodiment can be utilized for generating optimal regeneration scenarios for reuse timing and life extension, reuse, refurbish, and recycle.

Specifically, the surrogate AI 13 (glocal adapter management model) can present regeneration scenarios by simulating performance including environmental load, and lifetime prediction, for regeneration scenarios, such as the timing of cascaded reuse of the battery modules 21.

### Fourth Embodiment

Next, a fourth embodiment will be described. In the description of the fourth embodiment, contents similar to those of the first embodiment are omitted, and contents different from the first embodiment are described. The fourth embodiment describes a case where automatic updating (automatic generation) of the glocal adapter management model (surrogate AI 13) is performed.

The fourth embodiment can be implemented in combination with the first to three embodiments described above.

### Example of Functional Configuration

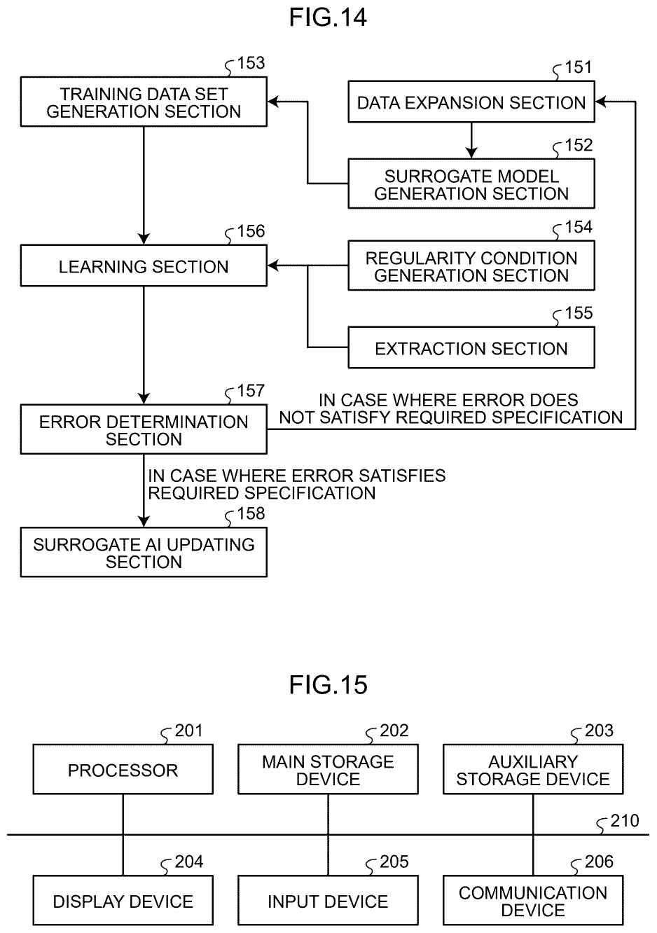

FIG. 14 is a diagram illustrating an example of the configuration according to the automatic update function of the generator 11 of the fourth embodiment. The generator 11 of the fourth embodiment includes a data expansion section 151, a surrogate model generation section 152, a training data set generation section 153, a regularity condition generation section 154, an extraction section 155, a learning section 156, an error determination section 157, and a surrogate AI updating section 158.

The data expansion section 151 expands the phenomenon simulation data set by conducting a parameter survey of the simulation while generating sampling points for numerical experiments on the global and local variables.

The surrogate model generation section 152 generates a group of surrogate models including one or more surrogate models with partial glocal variables for performance and reliability as inputs and partial phenomenon indicators as outputs, based on the phenomenon simulation data set.

The training data set generation section 153 prepares phenomenon indicators for learning of the surrogate AI 13, and sampling data for the global and local variables, by using the local variables and the global variables input to the group of surrogate models, and phenomenon indicators related to the performance and reliability output from the group of surrogate models.

The local variables indicate structures, material properties, boundary conditions and initial conditions of the device components, and the like that are components of the system. The global variables indicate system configuration specifications, load conditions, use environmental conditions, disturbances, and the like of the system in which the device component is a component.

The regularity condition generation section 154 generates constraint conditions by combining physical models based on the phenomenon mechanism, engineering models, and function candidates obtained from the function candidate library. The function candidate library includes energy functional and information entropy, and the like. The constraint conditions are used for facilitating the convergence of learning errors in the surrogate AI 13.

The extraction section 155 extracts the phenomenon indicators and phenomenon criteria regarding performance and reliability, and the feature quantities (latent variables) in the multivariable probability distribution related to load conditions, boundary conditions, configuration and structural conditions, material property condition, and initial conditions, by a generative AI method such as Normalizing-flow VAE.

The learning section 156 learns the spatial and temporal responses of phenomenon state quantities regarding performance and reliability, phenomenon criteria, and operators of differential equations, utilizing Neural Operator and Transformer, and the like. The differential equations indicate load conditions, boundary conditions, configuration and structural conditions, material property conditions, and initial conditions.

If the error in the learned surrogate AI 13 does not satisfy the required specification, the error determination section 157 requests the data expansion section 151 to expand the phenomenon simulation data set.

If the error in the learned surrogate AI 13 satisfies the required specifications, the error determination section 157 requests the surrogate AI updating section 158 to update (or generate) the surrogate AI 13.

The surrogate AI updating section 158 updates the surrogate AI 13 if the error is determined by the error determination section 157 to satisfy the required specification.

According to the fourth embodiment, the surrogate AI 13 (glocal adapter management model), which operates as a performance and lifetime management simulator, can continue to be updated as use environments, customer requirements, or device components are updated.

Lastly, the following describes an example of a hardware configuration of the information processing device 1 according to the above-described first to fourth embodiments.

### Example of Hardware Configuration

FIG. 15 is a diagram illustrating an example of a hardware configuration of the information processing device 1 of the first to the fourth embodiments. The information processing device 1 of the first to the fourth embodiments includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

The information processing device 1 does not need to include some of the above configurations. For example, if the information processing device 1 can use input and display functions of an external device, the information processing device 1 does not need to include the display device 204 and the input device 205.

The processor 201 executes a computer program read from the auxiliary storage device 203 into the main storage device 202. The main storage device 202 is memory such as ROM and RAM. The auxiliary storage device 203 is a hard disk drive (HDD), a memory card, or the like.

The display device 204 is, for example, a liquid crystal display and the like. The input device 205 is an interface for operating the information processing device 1. The display device 204 and the input device 205 may be implemented as a touch panel or the like having both display and input functions. The communication device 206 is an interface for communicating with other devices.

The computer program to be executed by the information processing device 1, for example, is provided as a computer program product in an installable or executable format file recorded on a computer-readable storage medium such as a memory card, a hard disk, a CD-RW, a CD-ROM, a CD-R, a DVD-RAM, and a DVD-R.

In addition, for example, the computer program to be executed on the information processing device 1 may be configured to be stored on a computer connected to a network 200 such as the Internet and to be provided by being downloaded via the network 200.

Moreover, for example, the computer program to be executed by the information processing device 1 may be configured to be provided via the network 200 such as the Internet without being downloaded. Specifically, the information processing may be executed through a so-called application service provider (ASP) type service that does not transfer the computer program, but implements processing functions only through execution instructions and result acquisition.

Moreover, for example, the computer program of the information processing device 1 may be configured to be provided in a manner preinstalled in a ROM, or the like.

The computer program executed by the information processing device 1 has a module configuration in which functions that can be implemented also by the computer program are included, among the functional configurations described above. Each of the functions, as actual hardware, is performed by the processor 201, which reads and executes a computer program from a storage medium, so that each of the functional blocks described above is loaded onto the main storage device 202. In other words, each of the functional blocks described above is generated on the main storage device 202.

Some of or all the functions described above may be implemented by hardware such as an integrated circuit (IC) without being implemented by software.

A plurality of processors 201 may be used for implementing the functions described above, and in this case, each of the processors 201 may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device, comprising a hardware processor connected to one or more memories and configured to:
acquire probability distribution data for global variables and probability distribution data for local variables, the probability distribution data for the global variables including at least one variable related to a global system in which a device of an adjustment target is included as a component of the global system, the probability distribution data for the local variables including at least one variable related to the device of the adjustment target;
predict at least one of a performance indicator of the device or a reliability indicator of the device by using a predictive model, the predictive model serving to predict at least one of the performance indicator or the reliability indicator by sampling the probability distribution data for the global variables and the probability distribution data for the local variables;
control a controllable variable value, a range of controllable variable values, or a probability distribution of controllable variable values among the local variables based on at least one of the performance indicator or the reliability indicator; and
generate, based on the controlled local variables, a glocal adapter management model serving to run a simulation to predict at least one of the performance indicator or the reliability indicator by the predictive model.

2. The information processing device according to claim 1, wherein the global variables includes at least one of a variable indicating a required specification of the device, a variable indicating a system configuration specification of the device, a variable indicating a load condition of the device, a variable indicating a use environmental condition of the device, or a variable indicating a disturbance of the device.

3. The information processing device according to claim 1, wherein the local variables includes at least one of a variable indicating a structure of the device, a variable indicating material properties of the device, a variable indicating boundary conditions of the device, a variable indicating initial conditions of the device, or a variable indicating individual differences of the device.

4. The information processing device according to claim 1, wherein the hardware processor is further configured to generate the predictive model from a group of surrogate models, the group including one or more surrogate models, each serving to predict at least one of the performance indicator or the reliability indicator by sampling the probability distribution data for the global variables and the probability distribution data for the local variables.

5. The information processing device according to claim 1, wherein the glocal adapter management model is a model outputting at least one of the performance indicator or the reliability indicator under control conditions that satisfy conditions of the device as determined by the local variables and required specifications of the global system as determined by the global variables.

6. The information processing device according to claim 5, wherein, in a case where the required specification of the global system determined by the global variable is not satisfied, the glocal adapter management model
changes at least one of the conditions of the device determined by the local variable or the conditions of the global system determined by the global variable, and
predicts again at least one of the performance indicator or the reliability indicator.

7. The information processing device according to claim 1, wherein the glocal adapter management model outputs at least one of the performance indicator or the reliability indicator, based on consensus control, model predictive control, or control by a multi-agent model.

8. The information processing device according to claim 1, wherein the glocal adapter management model outputs, as information indicating at least one of the performance indicator or the reliability indicator, a damage probability of the device, a probability distribution of the damage probability, or a risk value indicating a risk of the device.

9. The information processing device according to claim 8, wherein the risk value is represented by a product of a loss cost that indicates a magnitude of a loss and occurrence probability of the loss.

10. An information processing method implemented by a computer, the method comprising:
acquiring probability distribution data for global variables and probability distribution data for local variables, the probability distribution data for the global variables including at least one variable related to a global system in which a device of an adjustment target is included as a component of the global system, the probability distribution data for the local variables including at least one variable related to the device of the adjustment target;
predicting at least one of a performance indicator of the device or a reliability indicator of the device by using a predictive model, the predictive model serving to predict at least one of the performance indicator or the reliability indicator by sampling the probability distribution data for the global variables and the probability distribution data for the local variables;
controlling a controllable variable value, a range of controllable variable values, or a probability distribution of controllable variable values among the local variables based on at least one of the performance indicator or the reliability indicator; and
generating, based on the controlled local variables, a glocal adapter management model serving to run a simulation to predict at least one of the performance indicator or the reliability indicator by the predictive model.

11. A computer program product comprising a non-transitory computer readable recording medium on which a computer program executable by a computer is stored, the computer program instructing the computer to perform processing including:
acquiring probability distribution data for global variables and probability distribution data for local variables, the probability distribution data for the global variables including at least one variable related to a global system in which a device of an adjustment target is included as a component of the global system, the probability distribution data for the local variables including at least one variable related to the device of the adjustment target;
predicting at least one of a performance indicator of the device or a reliability indicator of the device by using a predictive model, the predictive model serving to predict at least one of the performance indicator or the reliability indicator by sampling the probability distribution data for the global variables and the probability distribution data for the local variables;
controlling a controllable variable value, a range of controllable variable values, or a probability distribution of controllable variable values among the local variables based on at least one of the performance indicator or the reliability indicator; and
generating, based on the controlled local variables, a glocal adapter management model serving to run a simulation to predict at least one of the performance indicator or the reliability indicator by the predictive model.
